(19) United States
(12) Patent Application Publication
(10) Pub. No.: US 2023/0350018 A1
(43) Pub. Date: Nov. 2, 2023

(54) Object Detection

(71) Applicant: APPLE INC., Cupertino, CA (US)

(72) Inventors: Nathaniel J. Dennis, Saratoga, CA (US); Jeffrey A. Sewell, Wyandotte, MI (US); Joseph Hakim, Jacksonville, OR (US)

(21) Appl. No.: 18/173,171

(22) Filed: Feb. 23, 2023

Related U.S. Application Data
(60) Provisional application No. 63/336,559, filed on Apr. 29, 2022.

(51) Int. Cl. G01S 7/41; G01S 13/88; G01S 13/75

(52) U.S. Cl. CPC G01S 7/412; G01S 13/886; G01S 13/75

(57) ABSTRACT

A system that includes a radar sensor configured to transmit radar waves receive a first group of reflected radar waves and a second group of reflected radar waves. A restraint includes a material that causes the transmitted radar waves to reflect off the restraint to generate the first group of reflected radar waves, and the second group of radar waves is reflected off objects other than the restraint. A controller is configured to determine a shape of the restraint based on the first group of reflected radar waves.

### CROSS-REFERENCE TO RELATED APPLICATIONS

This application claims the benefit of U.S. Provisional Application No. 63/336,559, filed on Apr. 29, 2022, the contents of which are hereby incorporated by reference in its entirety for all purposes.

### FIELD

The present disclosure relates generally to the field of detecting an object.

### BACKGROUND

An occupant restraint secures an occupant to a seat. In some instances, the occupant wears the occupant restraint incorrectly, or not at all.

### SUMMARY

One aspect of the disclosure is a system that includes a radar sensor positioned in a cabin of a vehicle and configured to transmit radar waves into the cabin and receive a first group of reflected radar waves and a second group of reflected radar waves. A restraint includes a material that causes the transmitted radar waves to reflect off the restraint to generate the first group of reflected radar waves, and the second group of radar waves is reflected off objects other than the restraint. A controller is configured to determine a shape of the restraint based on the first group of reflected radar waves.

Another aspect of the disclosure is a system that includes a sensor positioned in a cabin of a vehicle and configured to transmit a first electromagnetic wave into the cabin and receive a second electromagnetic wave, where the first electromagnetic wave includes first angular orientation. A material is located inside the cabin and is configured to cause the first electromagnetic wave to reflect off the material to generate the second electromagnetic wave with a second angular orientation. An angular difference between the first angular orientation and the second angular orientation is less than a threshold value.

Yet another aspect of the disclosure is a radar sensor that transmits radar waves toward an occupant restraint and receives reflected radar waves from the occupant restraint. A controller is configured to determine a shape of the occupant restraint based on the reflected radar waves and that the shape of the occupant restraint indicates the occupant restraint is being worn incorrectly by an occupant. The controller is configured to provide a notification to the occupant via an output component that the occupant restraint is being worn incorrectly.

### BRIEF DESCRIPTION OF THE DRAWINGS

FIGS. 1-2 are schematic illustrations of a side view and a front view, respectively, of a cabin of a vehicle.

FIG. 3 is an illustration of a portion of an embodiment of a restraint.

FIG. 4 is an illustration of a portion of another embodiment of a restraint.

FIG. 5 is a schematic illustration of electromagnetic waves propagating in the cabin of the vehicle of FIGS. 1-2.

FIG. 6 is a block diagram of a radar sensor.

FIG. 7 is a block diagram of a controller.

FIG. 8 is a flowchart that shows a process for determining a shape of a restraint.

### DETAILED DESCRIPTION

The disclosure herein relates to devices, systems, and methods that can detect whether a restraint is being misused by an occupant in a vehicle. Detecting whether a restraint is being misused can be accomplished using one or more sensors to detect and determine a three-dimensional shape of a restraint within a cabin of a vehicle. The three-dimensional shape of the restraint is compared to an expected shape to determine whether the restraint is being misused. Upon determining that the restraint is being misused, notification of the misuse can be provided, and an operating state of the vehicle can be changed.

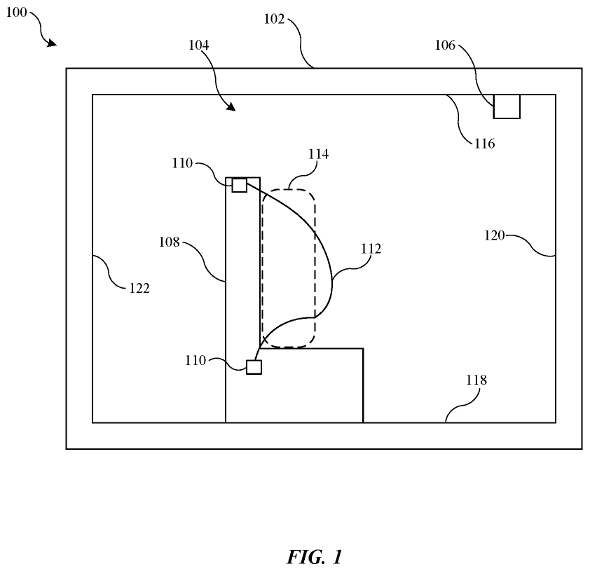

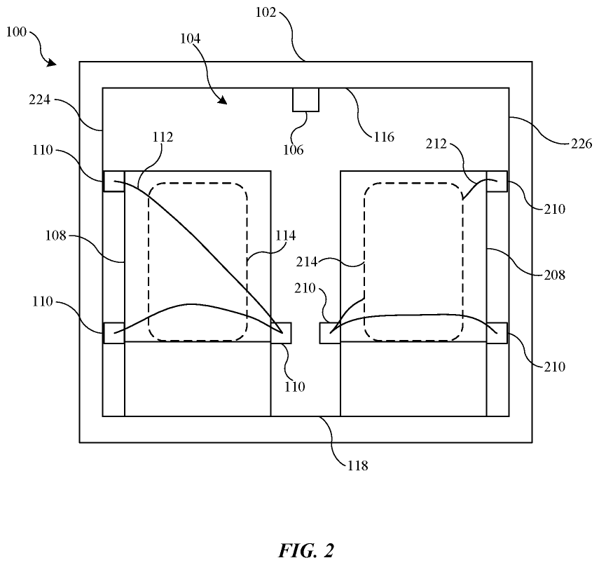

FIGS. 1-2 are schematic illustrations of a side view and a front view, respectively, of a cabin 104 of a vehicle 100. The vehicle 100 can be any type of vehicle including, but not limited to, gas or diesel-powered vehicles, electric vehicles, boat or marine vehicles, aircraft (e.g., airplanes, helicopters, etc.), remote-controlled vehicles, etc. The vehicle 100 may be configured using wheels, tracks, treads, fans, propellers, etc.

The vehicle 100 includes a vehicle body 102 that defines and at least partially encloses a cabin 104. The cabin 104 is the area inside the vehicle 100 which is occupied by an occupant when vehicle 100 moves from one location to another location. The cabin 104 includes a first seat 108 and a second seat 208, and both the first seat 108 and the second seat 208 are fixed (either directly or indirectly) to a floor 118 of the cabin 104. In some implementations, the first seat 108 and the second seat 208 are coupled to seat suspension systems (not shown) that are coupled to the vehicle body 102 and/or the floor 118 and are configured to absorb at least some of the forces imparted to the vehicle body 102 by road features as the vehicle 100 travels over a road. The cabin 104 is shown as having a rectangular cross-section, however the cabin 104 can have any cross-sectional shape that is compatible with the systems described herein.

The first seat 108 and the second seat 208 are configured to support occupants (e.g., the first seat 108 supports a first occupant 114 and the second seat 208 supports a second occupant 214). To secure the first occupant 114 and the second occupant 214 to the first seat 108 and the second seat 208, respectively, the vehicle 100 also includes a first restraint 112 and a second restraint 212. The first restraint 112 is shown with all portions of the first restraint 112 located in front of the first occupant 114. The second restraint 212 is shown with a portion of the second restraint 212 located behind the second occupant 214. The location of the second restraint 212 behind the second occupant 214 indicates the second restraint 212 is being misused (e.g., being worn incorrectly or not being worn at all) by the second occupant 214. The systems and methods described herein are configured to detect misuse of a restraint by an occupant and take an action accordingly.

The first restraint 112 is coupled to the first seat 108, the vehicle body 102, or both, via restraint anchors 110. The restraint anchors 110 fix the first restraint 112 in various locations to secure the first occupant 114 in the first seat 108. For example, as shown in FIGS. 1-2, the restraint anchors 110 are fixed in three locations (e.g., two of the restraint anchors 110 are positioned adjacent to a hip of the first occupant 114 and one of the restraint anchors 110 is positioned adjacent to a shoulder of the first occupant 114) to provide a three-point restraint. In some implementations, the first restraint 112 is movably coupled with a subset of the restraint anchors 110 and is releasably coupled with a remainder of the restraint anchors 110. For example, the first restraint 112 may be movably coupled with (e.g., the first restraint 112 can be unrolled from and/or rolled up using a spool) one of the restraint anchors 110 (e.g., the restraint anchor 110 positioned adjacent to a shoulder of the first occupant 114), may be fixed to another one of the restraint anchors 110 (e.g., the restraint anchor 110 positioned adjacent to a hip of the first occupant and below the restraint anchor 110 positioned adjacent to the shoulder of the first occupant 114), and may be releasably coupled with another one of the restraint anchors 110 that is positioned adjacent to the opposite hip of the first occupant 114 (e.g., via a latch movably positioned on the first restraint 112). Though three of the restraint anchors 110 are shown in FIGS. 1-2, more or fewer of the restraint anchors 110 may be used. For example, two of the restraint anchors 110 may be implemented for a two-point restraint, four of the restraint anchors 110 may be implemented for a four-point restraint, five of the restraint anchors 110 may be implemented for a five-point restraint, etc. As shown, the second restraint 212 is coupled with restraint anchors 210. The restraint anchors 210 are like the restraint anchors 110 and can be arranged as described with reference to the restraint anchors 110 on or around the second seat 208.

The vehicle 100 further includes a sensor 106 located inside the cabin 104. As shown, the sensor 106 is positioned on a roof 116 of the cabin 104. However, the sensor 106 can be positioned in various locations within the cabin 104. For example, the sensor 106 can be positioned on a front portion 120 of the cabin 104, on a rear portion 122 of the cabin 104, on a first side portion 224 of the cabin 104, or on a second side portion 226 of the cabin 104. In the example embodiment shown in FIGS. 1-2, one sensor 106 is shown. However, in some implementations two or more of the sensor 106 can be used in various locations. For example, two or more of the sensor 106 can be positioned on the roof 116, the front portion 120, the rear portion 122, the first side portion 224, and/or the second side portion 226.

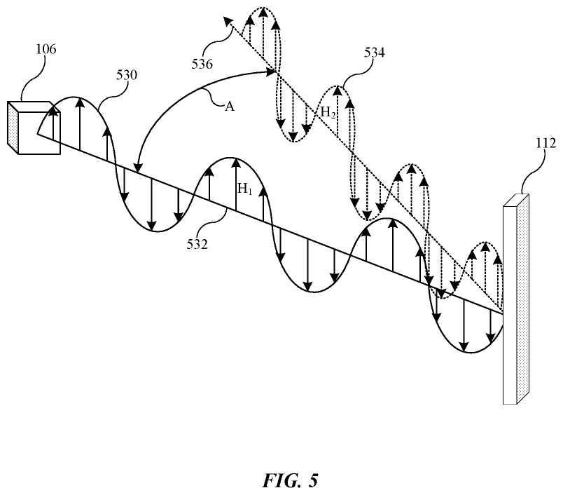

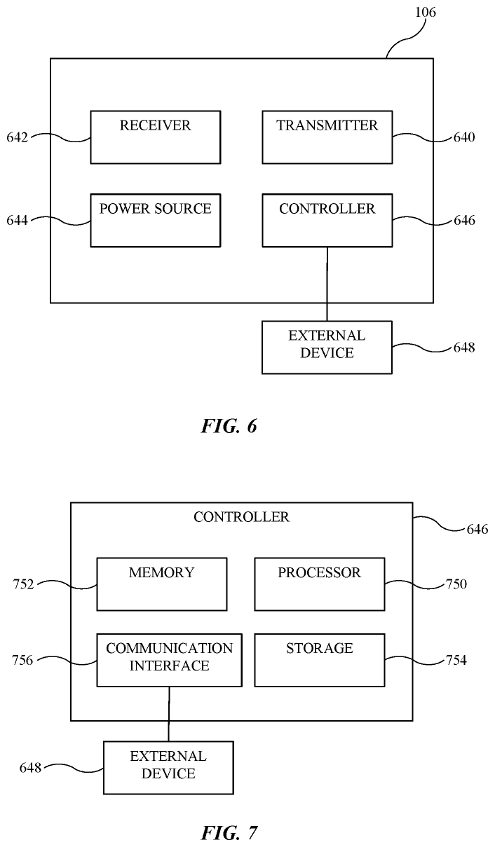

The sensor 106 is configured to transmit electromagnetic waves into the cabin 104 and to receive reflected electromagnetic waves that are reflected off objects located within the cabin 104. In some implementations, the sensor 106 transmits infrared waves into the cabin 104. In such implementations, the sensor 106 may be referred to as an infrared sensor or an infrared camera. The sensor 106 may also transmit radar (e.g., radio) waves into the cabin 104, in which case the sensor 106 may be referred to as a radar sensor or radar device. The sensor 106 is further described with reference to FIGS. 5-6.

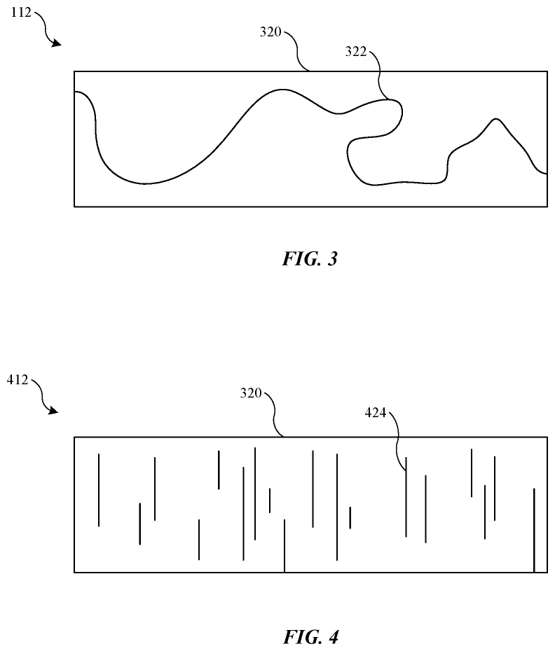

FIG. 3 is an illustration of a portion of an embodiment of the first restraint 112. The first restraint 112 is shown to include a substrate 320 and a material 322. The substrate 320 (which may also be referred to as “webbing”) is typically constructed from nylon and/or polyester fibers that are woven together to produce a strap that operates as the first restraint 112. The material 322 is a radar reflective material (e.g., a material that reflects a transmitted radar wave with a stronger signal than a material that is not radar reflective) that is woven with the substrate 320 such that the material 322 is fixed in the substrate 320. The material 322 may be a metal or metal fibers manufactured to produce a thread or a thin, flexible rod that can be woven with the substrate 320. In some implementations, the material 322 is a thread that includes silver. In some embodiments, other metals are used (e.g., steel, aluminum, nitinol, gold, platinum, copper, bronze, etc.). The material 322 may also be configured to cause a radar wave to be reflected with a specified polarization angle (e.g., the angle between the radar wave and an axis perpendicular to the axis along which the radar wave is traveling). The term “angular orientation” may also be used to refer to the polarization angle. The material 322 may be produced by wrapping a metallic foil around a flexible core (e.g., a silk fiber, a linen fiber, a polyester fiber, a nylon fiber, etc.). In some implementations, the material 322 is woven into the substrate 320 when the substrate 320 is manufactured. The material 322 may also be woven or otherwise coupled to the substrate 320 after the substrate 320 is manufactured.

As shown, the material 322 may be woven into the substrate 320 as a single thread or fiber that extends along the entire length of the substrate 320. In some implementations, the material 322 may include multiple threads that are woven into the substrate 320 and extend along the entire length of the substrate 320. The sensor 106 receives radar waves reflected from the material 322 and can determine a shape of the substrate 320 (and therefore the shape of the first restraint 112) based on the reflected radar waves. The material 322 may be configured in a non-repeating (e.g., random) arrangement on the substrate 320, as shown in FIG. 3. The sensor 106 may be configured to recognize the non-repeating arrangement and determine the shape of the substrate 320 based on the three-dimensional shape of the non-repeating arrangement. Implementations including a non-repeating pattern may be beneficial in determining a location of a specific portion of the substrate 320. Each feature of the material 322 (e.g., peaks, valleys, straight sections, curves, etc.) along the substrate 320 is unique, so determining locations of those unique features in three-dimensional space can aid in determining not only the shape of the substrate 320, but also in determining a size of the first occupant 114. For example, a peak of the material 322 may be located in a specific location along the length of the substrate 320. If the peak is located near the restraint anchor 110 positioned near the shoulder of the first occupant 114, that may indicate that the first occupant 114 is small. On the other hand, if the peak is located near the restraint anchor 110 to which the first restraint 112 is latched, that may indicate the first occupant 114 is large (e.g., a longer length of the first restraint 112 is required to secure a larger occupant than a smaller occupant, and the three-dimensional positions of features of the material 322 will change based on the size of the occupant). In some embodiments, the material 322 may be configured in a repeating pattern on the substrate 320. For example, the material 322 may be woven into the substrate 320 to produce shapes (e.g., squares, triangles, circles, etc.), letters, words, images, etc. in a pattern that is identifiable by the sensor 106 and/or a controller associated with the sensor 106. The sensor 106 may be configured to determine the shape of the substrate 320 based on the three-dimensional shape of the repeating pattern. The sensor 106 may also be configured to determine occupant size based on the number of repeated shapes indicated by the reflected radar wave. For example, if the repeating pattern includes triangles, more triangles that reflect the transmitted radar wave indicate a longer length of the first restraint 112, which indicates a larger occupant. In some implementations, the material 322 includes an identifying pattern on a surface of the material 322 that can be distinguished by the sensor 106 and/or a controller associated with the sensor 106. For example, the material 322 may include a series of etchings in the form of a bar code that can be distinguished by the sensor 106 and/or a controller associated with the sensor 106. The material 322 may also include a known geometric pattern that has a known positional relationship with respect to the first restraint 112. The geometric pattern may be interpreted by the sensor 106 to determine a three-dimensional position of the first restraint 112, a curvature of the first restraint 112, a position of the first restraint 112 with respect to the first occupant 114, and whether any portions of the first restraint 112 are obstructed from view by the sensor 106. Any combination of the non-repeating pattern, repeating pattern, and/or identifying pattern can be implemented in the embodiments of the first restraint 112 described herein. For example, the first restraint 112 may include a first portion of the substrate 320 where the material 322 is arranged in a non-repeating manner, a second portion of the substrate 320 where the material 322 is arranged in a repeating pattern, and a third portion of the substrate 320 where the material 322 is arranged in an identifying pattern.

FIG. 4 is an illustration of a portion of another embodiment of a restraint 412. The restraint 412 includes the substrate 320 and a material 424. The material 424 is like the material 322 except that multiple pieces of the material 424 are woven into the substrate 320 in various orientations as opposed to a length of the material 322 that extends along a length of the substrate 320 as described with reference to FIG. 3 (e.g., a single or multiple threads that extend continuously along the length of the substrate 320). The material 424 may be arranged in various lengths and/or orientations relative to the length and width of the substrate 320. As shown, the material 424 includes various lengths of the material 424 arranged along the width of the substrate 320 (e.g., transverse to the length of the substrate 320). The material 424 can also include various lengths of the material 424 arranged along the length of the substrate 320. In some implementations, the material 424 can include various lengths of the material 424 arranged in various orientations (e.g., along the width of the substrate 320, along the length of the substrate 320, and angled relative to the length and width of the substrate 320). In some embodiments the various lengths of the material 424 may be arranged like a bar code that can be distinguished by the sensor 106 and/or a controller associated with the sensor 106. Furthermore, the material 424 can be arranged in other manners than those described above. For example, the material 424 may be arranged to include straight lengths of the material 424 in combination with various shapes, letters, images, etc.

FIG. 5 is a schematic illustration of electromagnetic waves propagating in the cabin 104 of the vehicle 100 of FIGS. 1-2. As shown, the sensor 106 transmits an electromagnetic wave 530 that has a frequency range between four hundred megahertz and thirty-six gigahertz, inclusive (e.g., a radar wave) toward the first restraint 112 along an axis 532. The electromagnetic wave 530 has a predetermined angular orientation (e.g., predetermined polarization or incident polarization) such that the electromagnetic wave 530 is oriented in a generally vertical direction (e.g., the peaks and valleys of the electromagnetic wave 530 extend generally vertically up and generally vertically down, respectively) with an amplitude of H₁. The electromagnetic wave 530 reaches the first restraint 112 and the electromagnetic wave 530 reflects off the first restraint 112 to produce a reflected electromagnetic wave 534 (e.g., a reflected radar wave). The reflected electromagnetic wave 534 extends away from the first restraint 112 along an axis 536 such that there is an angle A (e.g., an angle of reflection) between the axis 532 and the axis 536. As described above with respect to FIG. 3, the first restraint 112 includes a radar reflective material (e.g., the material 322). In some implementations, the material 322 causes the reflected electromagnetic wave 534 to have an amplitude (H₂ as shown in FIG. 5) that is higher than an amplitude of waves reflected off other objects in the cabin 104 (e.g., seat materials like cloth and/or leather, clothing and/or skin of occupants, etc.). Additionally, the material 322 may cause the reflected electromagnetic wave 534 to maintain the predetermined angular orientation of the electromagnetic wave 530. In the example embodiment shown in FIG. 5, the material 322 causes reflected electromagnetic wave 534 to maintain the polarization of the electromagnetic wave 530 such that the reflected electromagnetic wave 534 is oriented in a generally vertical direction like the electromagnetic wave 530. In other embodiments, the material 322 causes the reflected electromagnetic wave 534 to be oriented in a direction other than generally vertical (e.g., generally horizontal, generally at a forty-five-degree angle, etc.).

For explanation purposes, FIG. 5 shows only one transmitted wave (the electromagnetic wave 530) and one reflected wave (the reflected electromagnetic wave 534). However, the sensor 106 is configured to transmit multiple electromagnetic waves simultaneously and receive multiple reflected electromagnetic waves simultaneously. Accordingly, the sensor 106 can simultaneously receive a first group of reflected electromagnetic waves (e.g., electromagnetic waves reflected off the first restraint 112 that includes the material 322) and a second group of electromagnetic waves (e.g., electromagnetic waves reflected off objects other than the material 322). Furthermore, though not shown in FIG. 5, the sensor 106 (or another one or the sensor 106 positioned in a different location in the cabin 104) may also receive the electromagnetic wave 534.

FIG. 6 is a block diagram of the sensor 106. The sensor 106 is shown to include a transmitter 640, a receiver 642, a power source 644, and a controller 646 that is electronically coupled to an external device 648.

The transmitter 640 is configured to generate electromagnetic waves (e.g., radar waves) and direct the electromagnetic waves into the cabin 104 via an antenna (not shown). The transmitter 640 can generate the electromagnetic waves having a specified wavelength. The receiver 642 is configured to receive electromagnetic waves that are reflected off objects in the cabin 104. For example, the receiver 642 may receive electromagnetic waves reflected off the first seat 108, the first occupant 114, the first restraint 112, the material 322, and any other objects that may be located inside the cabin 104. The power source 644 is configured to provide power to the sensor 106 to operate the receiver 642, the power source 644, and the controller 646. In some embodiments, the power source 644 is dedicated to the sensor 106 (e.g., the power source 644 does not provide power to other devices or systems within the vehicle 100). In some implementations, the power source 644 is part of another system of the vehicle 100 and is electrically coupled with the sensor 106 to provide power to the sensor 106.

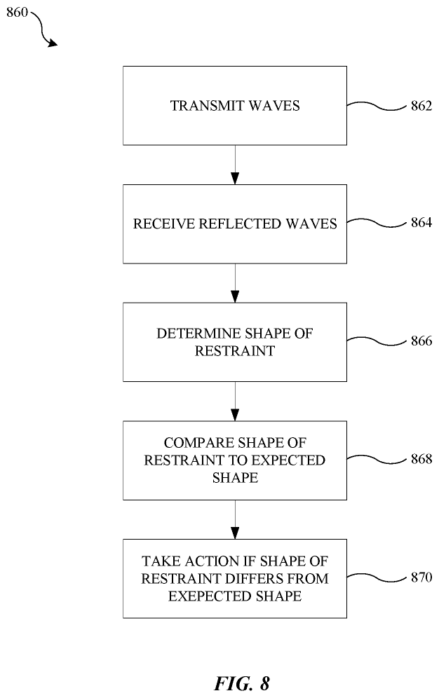

The controller 646 is in communication with the transmitter 640 and the receiver 642 and is configured to differentiate between objects located inside the cabin 104 based on the reflected electromagnetic waves received by the receiver 642. The controller 646 is also configured to determine the three-dimensional shapes of the objects located inside the cabin 104 based on the reflected electromagnetic waves received by the receiver 642. For example, the controller 646 is configured to determine a three-dimensional shape of the material 322 based on the reflected electromagnetic waves. The controller 646 is further described with reference to FIGS. 7-8.

The external device 648 is in communication with the controller 646 and is configured to communicate with an occupant (e.g., the first occupant 114, the second occupant 214, etc.) inside the cabin 104. The external device 648 (also referred to as an output component) can include a display that is configured to provide information to the first occupant 114 and the second occupant 214. The information can be provided visually and/or audially. The external device 648 can also include an audio device (e.g., a speaker) that does not provide visual information. Additionally, the external device 648 can include a haptic device located in or on the first seat 108 and the second seat 208 that is configured to provide a haptic notification to the first occupant 114 and/or the second occupant 214.

In some implementations, the external device 648 can be coupled to the vehicle 100. For example, the external device 648 may include a display located on a dashboard, a console, the first seat 108, the second seat 208, or any other surface located inside the cabin 104 and is configured to provide information to first occupant 114 and/or the second occupant 214. In some embodiments, the external device 648 can be independent of (e.g., not coupled to) the vehicle 100. For example, the external device 648 may include a mobile device (e.g., a mobile phone, a tablet computer, a smart watch, a laptop computer, etc.). The external device 648 may also include a computing device or system that controls operation of the vehicle 100.

FIG. 7 is a block diagram of the controller 646. The controller 646 may be used to implement the systems and methods disclosed herein. For example, the controller 646 may receive data related to the reflected electromagnetic waves from the receiver 642 and control output of the external device 648 according to the data to provide a notification to the first occupant 114 and/or the second occupant 214 and/or to control operation of the vehicle 100. In an example hardware configuration, the controller 646 generally includes a processor 750, a memory 752, a storage 754, and a communications interface 756. The processor 750 may be any suitable processor, such as a central processing unit, for executing computer instructions and performing operations described thereby. The memory 752 may be a volatile memory, such as random-access memory (RAM). The storage 754 may be a non-volatile storage device, such as a hard disk drive (HDD) or a solid-state drive (SSD). The storage 754 may form a computer readable medium that stores instructions (e.g., code) executed by the processor 750 for operating the external device 648 and/or the vehicle 100, for example, in the manners described above and below. The communications interface 756 is in communication with, for example, the external device 648, for sending to and receiving from various signals (e.g., control signals and/or notifications).

FIG. 8 is a flowchart that shows a process 860 for determining a shape of a restraint For example, the shape of a restraint can be a geometric shape of the restraint in three-dimensional space. The shape of a restraint can also be an absolute position of the restraint in three-dimensional space. Furthermore, the shape of a restraint can be a position of the restraint relative to other objects in the vehicle 100 (e.g., the seats, floor, roof, etc.), a pattern exhibited by the restraint, an angular orientation of the restraint, or a combination of any of the above characteristics. In some embodiments, the shape of a restraint can be a position of the restraint relative to an occupant (e.g., relative to the torso, head, neck, and/or shoulders of the occupant), and the shape of the restraint can be used to determine whether the occupant is out of position (e.g., laying down, head resting against a support, feet not on the floor, etc.).

The process 860 can be implemented at least in part by the sensor 106 and the controller 646. At operation 862, waves are transmitted. For example, the transmitter 640 transmits electromagnetic waves (e.g., transmitted electromagnetic waves) with a specified wavelength into the cabin 104 of the vehicle 100. As described above, the electromagnetic waves may be transmitted simultaneously as a group (e.g., the first group of electromagnetic waves, the transmitted electromagnetic waves, etc.). Each of the transmitted electromagnetic waves contacts an object. For example, the transmitted electromagnetic waves may contact the first seat 108, the second seat 208, the first occupant 114, the second occupant 214, the restraint anchors 110, the restraint anchors 210, the roof 116, the floor 118, the front portion 120, the rear portion 122, the first side portion 224, the second side portion 226, and any other object located inside the cabin 104. Upon contacting the objects inside the cabin 104, the transmitted electromagnetic waves reflect off the objects and become reflected electromagnetic waves that have the specified wavelength (e.g., the same wavelength as the transmitted electromagnetic waves).

At operation 864, the reflected electromagnetic waves are received. For example, after being reflected off the objects in the cabin 104, the reflected electromagnetic waves reach the receiver 642, which receives the reflected electromagnetic waves.

At operation 866, a shape of a restraint is determined. For example, data corresponding to the reflected electromagnetic wave (e.g., wave height, wavelength, polarization angle, etc.) is analyzed by the controller 646. In some implementations, the controller 646 compares wave amplitudes (e.g., heights) of all the reflected electromagnetic waves, where a higher wave amplitude indicates a stronger reflected signal. In such implementations, the controller 646 may receive a first group of reflected electromagnetic waves that reflect off the material 322 and/or the material 424 and a second group of reflected electromagnetic waves that reflect off other objects located inside the cabin 104. Because the material 322 and the material 424 are radar reflective materials, the amplitude of the first group of electromagnetic waves may be higher than the amplitude of the second group of electromagnetic waves. To determine the shape of a restraint (e.g., the first restraint 112 and/or the second restraint 212), the controller 646 analyzes the data from the first group of reflected electromagnetic waves.

In another implementation, the controller 646 compares angular orientations (e.g., polarization angles) of all the reflected electromagnetic waves to the angular orientation of the transmitted electromagnetic wave. As described, the material 322 and the material 424 may be configured to cause the reflected electromagnetic wave to have a predetermined angular orientation. Accordingly, the controller 646 may receive a first group of reflected electromagnetic waves that have the predetermined angular orientation (thereby indicating that the first group of reflected electromagnetic waves reflected off the material 322 and/or the material 424) and a second group of reflected electromagnetic waves that does not have the predetermined angular orientation (thereby indicating that the second group of reflected electromagnetic waves reflected off objects other than the material 322 or the material 424). In some embodiments, the predetermined angular orientation of the first group of reflected electromagnetic waves may differ from the angular orientation of the transmitted wave by less than a threshold value (e.g., less than ten degrees difference, less than five degrees difference, less than one degree difference, etc.). In such embodiments, to determine the shape of the first restraint 112 and/or the second restraint 212, the controller 646 determines that the difference between the angular orientation of the first group of reflected electromagnetic waves and the angular orientation of the transmitted electromagnetic waves is less than the threshold value, and the controller 646 analyzes the data from the first group of reflected electromagnetic waves.

In some implementations, the controller 646 determines which group of reflected electromagnetic waves to analyze based on a pattern of the reflected electromagnetic waves. As described, the material 322 and the material 424 may be configured in various shapes, patterns, or codes (e.g., bar codes) that the controller 646 can recognize. Accordingly, the controller 646 may receive a first group of reflected electromagnetic waves that have a bar code pattern, where the bar code indicates the first group of electromagnetic waves reflected off the material 322 and/or the material 424. The controller 646 may also receive a second group of reflected electromagnetic waves that do not have the bar code pattern, indicating that the second group of reflected electromagnetic waves reflected off objects other than the material 322 or the material 424. To determine the shape of the first restraint 112 and/or the second restraint 212, the controller 646 analyzes the data from the first group of reflected electromagnetic waves.

The controller 646 may determine the three-dimensional shape of the material 322 or the material 424 by, for example, using a time-of-flight method. For example, the controller 646 can determine a three-dimensional location of a point on a surface of the material 322 and/or the material 424 based the time elapsed between sending the transmitted electromagnetic wave into the cabin 104 via the transmitter 640 and receiving a reflected electromagnetic wave via the receiver 642. A shorter elapsed time indicates the reflective surface is closer to the receiver 642 and a longer elapsed time indicates the reflective surface is further from the receiver 642. The controller 646 may also determine a three-dimensional location of a point on a surface of the material 322 and/or the material 424 based on the angle from which the reflected electromagnetic wave is received by the receiver 642. A more acute angle indicates the reflective surface is generally in front of the receiver 642. Amore obtuse angle indicates the reflective surface is generally to a side of the receiver 642. Using these methods in combination, the controller 646 can determine the three-dimensional shape of the material 322 and/or the material 424. Furthermore, because the material 322 and/or the material 424 is woven into the first restraint 112 and/or the second restraint 212, the three-dimensional shape of the first restraint 112 and the second restraint 212 corresponds to the three-dimensional shape of the material 322 and/or the material 424. Accordingly, the controller 646 determines the three-dimensional shape of the first restraint 112 and the second restraint 212 based on the reflected electromagnetic waves. Other known methods may also be used to determine the three-dimensional shape of the first restraint 112 and the second restraint 212.

At operation 868, the shape of a restraint is compared to an expected shape. For example, the memory 752 and/or the storage 754 may include one or more expected shapes of a restraint used in a vehicle. The expected shapes may include an expected shape for a three-point restraint like the first restraint 112 and the second restraint 212. The expected shapes may also include an expected shape for a five-point restraint and any other type of restraint that may be used. For example, an expected shape of a three-point restraint may include three anchor points and a shape of the restraint that indicates the restraint is in a position around the occupant to secure the occupant. The expected shape does not include large discontinuities in the restraint, as a large discontinuity may indicate the restraint is being misused.

The controller 646 compares the determined shape of the restraint (e.g. the three-dimensional shape determined in operation 866) to the expected shape. In some implementations, the controller 646 compares the determined shape of the restraint to the expected shape by using three-dimensional geometric techniques. For example, the controller 646 may compare locations of various points along the restraint to the expected belt shapes. The controller 646 may also compare the determined shape of the restraint to the expected shape using a trained neural network that is trained to determine whether the determined shape of the restraint corresponds to the expected shape. The trained neural network may be trained using a large number of examples of shapes of restraints with ground truth information indicating whether the shape of the restraint is an expected shape or not an expected shape (e.g., a shape that corresponds to misuse of the restraint).

For example, the determined shape of the first restraint 112 and the determined shape of the second restraint 212 are shown in FIGS. 1-2. The three-dimensional shape of the first restraint 112 indicates that the first restraint 112 is being worn correctly (e.g., the three-dimensional geometric technique indicates the location of various points along the first restraint 112 correspond to the expected shape of the first restraint 112 and/or the trained neural network determined that the first restraint 112 exhibits an expected shape). However, the three-dimensional shape of the second restraint 212 includes a discontinuity where the shape of the second restraint 212 is not clear (e.g., the three-dimensional geometric technique indicates the location of various points along the second restraint 212 do not correspond to the expected shape of the second restraint 212 and/or the trained neural network determined that the second restraint 212 does not exhibit an expected shape). As shown in FIG. 2, the discontinuity may indicate that the second occupant 214 moved a portion of the second restraint 212 behind the second occupant 214 (e.g., the portion of the second restraint 212 is behind the second occupant 214 or is behind the second seat 208) such that the second occupant 214 prevents the receiver 642 from receiving a reflected electromagnetic wave from the portion of the second restraint 212 that is behind the second occupant 214. The discontinuity indicates the second restraint 212 is being misused by the second occupant 214. In some implementations, a length of the discontinuity must be greater than a threshold length for the controller 646 to determine that the second restraint 212 is being misused. For example, the second restraint 212 may exhibit the correct three-dimensional shape but may also have a small discontinuity, which may indicate that an arm of the second occupant 214 is in front of the second restraint 212. In such instances, the controller 646 may not determine that the second restraint 212 is being misused. In some implementations, a discontinuity must be detected for a threshold duration before the controller 646 determines that the discontinuity indicates that the second restraint 212 is being misused. For example, a discontinuity may occur when an arm of the second occupant 214 moves in front of the second restraint 212 to pick up a drink from a cup holder located in a center console of the vehicle 100. The discontinuity may then disappear when the arm of second occupant 214 moves back to its original position.

In addition to the misuse case described above, various other misuse cases will result in a determined three-dimensional shape that does not match the expected shape. For example, the second restraint 212 may be latched to the restraint anchor 210 and the second occupant 214 may sit on top of the second restraint 212. The second restraint 212 may be left unlatched and the second occupant 214 may sit on the second seat 208 while leaving the second restraint 212 hanging next to the second occupant 214. The second occupant 214 may latch the first restraint 112 to the restraint anchor 210 and then sit on the second seat 208 while leaving the second restraint 212 hanging next to the second occupant 214. The second occupant 214 may put the second restraint 212 under an arm of the second occupant 214 instead of over a shoulder of the second occupant 214. The second occupant 214 may wrap all portions of the second restraint 212 around the second seat 208 and then latch the second restraint 212 to the restraint anchor 210.

In addition to misuse cases, the controller 646 may also determine that a restraint is being misused based on a position of the occupant, as indicated by the shape of the restraint. For example, the second restraint 212 may not exhibit any discontinuities but may still exhibit a three-dimensional shape that is different than the expected shape. Such differences can occur when the second occupant 214 is positioned improperly in the second seat 208. For example, the feet of the second occupant 214 may be on a surface other than the floor 118 (e.g., a dashboard, a console, out a window, etc.). As another example, the head of the second occupant 214 may be against the second side portion 226 (e.g., a support, a window, etc.) or may be facing backward (e.g., turning the body to look at another occupant). In these examples, the three-dimensional shape of the second restraint 212 may not match the expected shape, and the controller 646 may take an action accordingly. Accordingly, the controller 646 may determine that the restraint is being worn incorrectly by determining that a position of the restraint relative to the occupant is different than an expected position of the restraint.

At operation 870, an action is taken if the determined three-dimensional shape differs from the expected shape. For example, after determining that the three-dimensional shape of the second restraint 212 does not match the expected shape (e.g., three-dimensional shape of the second restraint 212 indicates the second restraint 212 is being misused), the controller 646 may direct the external device 648 to change an operating state of the vehicle 100. As used here, the term “change an operating state” refers to one or more of: preventing the vehicle 100 from moving, causing the vehicle 100 to move to a safe location, providing a visual notification or alert of misuse (e.g., via an output component coupled to the vehicle 100 or a mobile device associated with the occupant misusing the restraint), providing an audible notification or alert of misuse (e.g., via an output component located in the vehicle 100 or a mobile device associated with the occupant misusing the restraint). For example, an output component may include a video display, audio speakers, lighting devices, haptic devices, etc. For example, if the controller 646 detects the misuse of the second restraint 212 while the vehicle 100 is not in motion, the controller 646 may cause visual and/or audio warnings to be broadcast within the cabin 104 (e.g., via a display coupled to the vehicle 100 or a mobile device associated with the occupant misusing the restraint) and may prevent the vehicle 100 from moving until the second restraint 212 exhibits the expected shape. In implementations where the controller 646 detects misuse of the second restraint 212 while the vehicle 100 is in motion, the controller 646 may cause the vehicle 100 to move to a safe location and stop until the second restraint 212 exhibits the expected shape and/or may also cause visual and/or audio warnings to be broadcast within the cabin 104.

In addition to determining misuse of restraints as described above, the system and methods described herein can be implemented to determine other aspects of the vehicle 100 and the occupants therein. For example, the sensor 106 can detect whether each occupant is in a corresponding seat and classify each occupant within the vehicle 100 (e.g., determine whether each occupant is a child, adult, male, female, etc.). The sensor 106 can also be used to detect whether a child is present in a child seat to prevent a child from being left in the vehicle 100. Furthermore, the sensor 106 can be used to monitor vital signs (e.g., heart rate, respiratory rate, temperature, etc.) of occupants within the vehicle 100. The sensor 106 may also be configured to detect non-seated occupants or critically out of position occupants within the vehicle 100. In response to detecting any of these additional characteristics, the controller 646 may change the operating state of the vehicle 100.

Furthermore, the system and methods described herein can also be used during a vehicle event (e.g., a collision, a hard-braking event, a sudden change in direction, etc.) to record positions of occupants as the vehicle event occurs. If one or more airbags deploy during the vehicle event, the deployment of the airbag(s) may be adjusted based on the position of the occupants and the contact between the occupants and the airbag(s). For example, airbag deployment time may be changed (e.g., deployed earlier or later than if the occupant is positioned correctly), suppressed (e.g., deployed with more or less velocity than if the occupant is positioned correctly, or prevented (e.g., deployment of an airbag may be prevented if it is determined that deploying the airbag may not be beneficial to the occupant based on the position of the occupant).

As described above, one aspect of the present technology is the gathering and use of data available from various sources for use during operation of the devices and systems disclosed herein. As an example, such data may identify the user and include user-specific settings or preferences. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, a user profile may be established that stores occupant related information that allows determining misuse of a restraint according to the occupant related information. Accordingly, use of such personal information data enhances the user's experience.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of storing a user profile for determining misuse of a restraint, the present technology can be configured to allow users to select to “opt in” or “opt out” of participation in the collection of personal information data during registration for services or anytime thereafter. In another example, users can select not to provide data regarding usage of specific applications. In yet another example, users can select to limit the length of time that application usage data is maintained or entirely prohibit the development of an application usage profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, occupant related information may be determined each time the system is used, such as by sensing occupant related data when an occupant enters a vehicle, and without subsequently storing the information or associating with the particular user.

What is claimed is:

1. A system, comprising:
a radar sensor positioned in a cabin of a vehicle and configured to transmit radar waves into the cabin and receive a first group of reflected radar waves and a second group of reflected radar waves; and
a restraint comprising a material that reflects the transmitted radar waves to generate the first group of reflected radar waves, wherein objects other than the material reflect the transmitted radar waves to generate the second group of reflected radar waves,
wherein a shape of the restraint is determined based on the first group of reflected radar waves.

2. The system of claim 1, wherein the restraint includes a substrate, and the material is arranged in a non-repeating manner on the substrate.

3. The system of claim 1, wherein the material causes the first group of reflected radar waves to reflect off the restraint according to a predetermined angular orientation.

4. The system of claim 1, wherein a difference between an angular orientation of the first group of reflected radar waves and an angular orientation of the transmitted radar waves is less than a threshold value.

5. The system of claim 1, wherein the shape of the restraint is compared to an expected shape.

6. The system of claim 5, wherein operation of the vehicle is controlled when the shape of the restraint indicates the restraint is being misused.

7. The system of claim 1, wherein the material comprises silver that is woven into a substrate of the restraint.

8. The system of claim 7, wherein the material includes an identifying pattern on a surface of the material.

9. The system of claim 1, wherein the determined shape of the restraint is a three-dimensional shape.

10. A system, comprising:
a sensor positioned in a cabin of a vehicle and configured to transmit a first electromagnetic wave toward a material located in the cabin and receive a second electromagnetic wave reflected from the material located in the cabin, wherein the first electromagnetic wave has a first angular orientation and the second electromagnetic wave has a second angular orientation,
wherein an angular difference between the first angular orientation and the second angular orientation is less than a threshold value.

11. The system of claim 10, wherein the sensor is positioned on a roof of the cabin.

12. The system of claim 10, wherein the material is configured to cause the first electromagnetic wave to reflect off the material to generate the second electromagnetic wave.

13. The system of claim 10, further comprising a controller configured to determine a three-dimensional shape of the material based on the second electromagnetic wave.

14. The system of claim 13, wherein the three-dimensional shape of the material corresponds to a shape of an occupant restraint.

15. The system of claim 14, wherein the controller is configured to change an operating state of the vehicle when the shape of the occupant restraint indicates the occupant restraint is being misused.

16. A system, comprising:
an occupant restraint configured to reflect radar waves transmitted by a radar sensor,
wherein a shape of the occupant restraint is determined based on the reflected radar waves, and the shape of the occupant restraint indicates the occupant restraint is being worn incorrectly by an occupant,
wherein a notification is provided to the occupant via an output component that the occupant restraint is being worn incorrectly.

17. The system of claim 16, wherein a vehicle is prevented from operating until the shape of the occupant restraint indicates the occupant restraint is being worn correctly, wherein the occupant restraint is located in the vehicle.

18. The system of claim 16, wherein the shape of the occupant restraint being different than an expected shape of the occupant restraint indicates the occupant restraint is being worn incorrectly.

19. The system of claim 16, wherein a position of the occupant restraint relative to the occupant being different than an expected position of the occupant restraint indicates the occupant restraint is being worn incorrectly.

20. The system of claim 16, wherein the occupant restraint includes a radar reflective material that is arranged in a non-repeating manner.
